(19) United States
(12) Patent Application Publication
(10) Pub. No.: US 2018/0131535 A1
(43) Pub. Date: May 10, 2018

(54) SYSTEM, APPARATUS, AND METHOD FOR INFORMATION RETRIEVAL

(71) Applicant: CHERRYTOMATO8, Las Vegas, NV (US)

(72) Inventors: Ron Johan, Queens Park (AU); Gabriel DAHER, Long Point (AU); Daniel Ming On WU, Chatswood (AU)

(21) Appl. No.: 15/637,700

(22) Filed: Jun. 29, 2017

(30) Foreign Application Priority Data
Jun. 30, 2016 (AU) 2016902569

(51) Int. Cl. H04L 12/28; G06F 17/30; H04N 21/458; H04N 21/436

(52) U.S. Cl. CPC H04L 12/2812; G06F 17/30864; H04N 21/458; H04L 65/608; H04L 12/2816; H04L 12/282; H04L 2012/285; H04N 21/43615

(57) ABSTRACT

A content retrieval control system includes a management center, programming capability, and one or more managed terminals. The managed terminals are connectable to content repositories. The content retrieval control system includes one or more association registers associating each managed terminal with the programming capability. The content retrieval control system includes programmable content delivery schedules for each managed terminal storing content identification information identifying selected content. The programming capability programs the content delivery schedules with content identification information identifying content in the content repositories for each managed terminal with which the programming terminal is associated. The management center delivers the content delivery schedules including content identification information to each corresponding managed terminal. Each managed terminal is adapted to use the content identification information to retrieve content identified by the content information from a content repository.

### RELATED APPLICATION

This application claims the benefit of priority from Australian Patent Application No. 2016 902569, filed on Jun. 30, 2016, the entirety of which is incorporated by reference.

### FIELD OF THE INVENTION

This invention relates to a method apparatus and system to improve the delivery of content through a wide area communication network such as the internet.

The invention can be applied to improving management and user experience when accessing video content, audio content or automation sequences via the internet.

### BACKGROUND OF THE INVENTION

The internet provides access to multiple providers of free and paid content such as audio, including talking books, music and video such as films and music video clips. This content is generally directly accessed by individuals using devices such as personal computers, tablets and smart phones which are connected to the internet via a broadband connection using wireless networks such as WiFi, cellular, LTE, 5G and the like or wired networks such as ADSL, cable modem, optical fiber and the like.

While the majority of the population have the technical knowledge to allow them to enjoy immediate access to content available via the internet, there are some that are less technically able, including the disabled, the elderly and the very young that may find the experience of accessing content via the internet to be difficult or impossible.

FR2878110 discloses a content delivery system which enables a user of a remote device, such as a mobile phone, to facilitate access to content by a second terminal. The system has a client server (5) with client register and a content catalogue listing available content, a planning server (6) and a content server (4), whereby a mobile phone user (2) can register with client server (5) [0054], select content from the catalogue on server (5), the client server (5) transmits the client selection to planning server (6) [0057], which adds network information, and stores the content request. Server (6) includes the addresses of the selected content and receiving terminal register (39). Server (6) calculates download transmission duration time etc. Information about the status and progress of the content delivery are regularly sent by server (5) and/or server (6) to the mobile phone (6). User 920 consults the catalogue (26) in the server (5) [0088] and selects content for delivery to the terminal (3) with delivery time. Server (5) sends the request to server (6), which retrieves the content address from memory (39), and selects the fastest content store (4) [0096], and stores the access information in (44). The receiving terminal (3) consults the register (44) and retrieves the content address [00113], and downloads the content from server (4).

FR2878110 teaches a closed network content access system allowing a user at a first location utilizing a control terminal, such as a mobile phone, to nominate content to be retrieved by a receiving terminal at a second location from one or more databases situated at a third location. This is achieved by the user at the first location using the control terminal to nominate the address of the server where the content is held in a database associated with the system situated at the third location, the address is stored in a database directory regularly interrogated by the receiving terminal at the second location. On detecting the presence of a valid entry in the database directory, the receiving terminal accesses the nominated database location to retrieve the content.

The system taught in the abovementioned patent application has a number of deficiencies, including those set out below.

It discloses access to content held in databases associated with the system with content location information of content held in content server (4) recorded in the client server (5) and the planning server (6), but does not disclose access to third-party content held on the internet at locations unassociated with the system.

It teaches direct access to the servers where the digital content is held. This may be impractical for content held in various sites on the internet where the address may not be known to one or more intended recipients.

It teaches that the receiving terminal is constantly interrogating the database directory used to store the address of the content, which is wasteful both of computer resources and network bandwidth.

It teaches the use of FTP to download files but does not disclose streaming protocols that are more appropriate for video and audio applications and may address copyright infringement issues that may be associated with downloading content.

It teaches the scheduled downloading of content by the receiving terminal but does not disclose scheduled playback. Streaming methods support the commencement of playback of content without the need to download the entire file associated with the content.

The arrangement of FR2006053986 involves a large amount of content access management on the part of the servers (5) and (6).

It is desirable to provide a more streamlined process enabling a playback terminal to access content controlled by a separate terminal.

It is desirable to provide a content access system and method which does not require a playback terminal to retrieve content access information.

It is desirable to provide a content access system and method in which a programming terminal can nominate content access information from one or more content servers.

It is desirable to provide a system which enables the association of one or more control terminals with a plurality of receiving terminals, allowing a plurality of receiving terminals to access and playback the same content.

It is desirable to provide a system which enables the association of content with home automation.

It is desirable to provide a system which enables the remote management of the receiving terminal whereby the user at the first location is able to discern the status of the receiving terminal or whether it is in fact functioning correctly.

It is desirable to provide a system which enables the use of any type of data encryption by the receiving terminal to obtain the database directory storing the address of the content to mitigate a potential security vulnerability affecting the entire system.

It is desirable to provide a system which enables the use of a VPN by the receiving terminal to access the database directory storing the address of the content. Accessing content without a VPN may require the user to configure port forwarding in their broadband router or use static IP addressing, requiring IP networking skills that are beyond most users.

The following terminology is used in the description and drawings:

A user streaming-player device (USPD) is a device that retrieves content from an IP network such as the internet in the form of a data stream and plays it immediately or based on a schedule. The content may include audio, video and automation sequences. A USPD includes a processor, communication means, playlist storage, and may include one or more of the following: content buffering storage, one or more displays which may include light emitting diodes (LEDs) a screen or a touch-screen, one or more speakers, one or more microphones, one or more cameras, one or more home automation network interface device, a gesture control interface, a wired or wireless LAN interface such as Ethernet or WiFi, a wired or wireless WAN interface such as Ethernet or cellular including LTE, 3G, 4G, 5G etc., one or more servo-motor or actuator.

A USPD may be a dedicated device, such as a toy, or may be a software application, or App, executing on a third-party computer platform such as a smart phone, tablet or personal computer (PC).

The following terms and abbreviations are used in the description:
HTTPS—hypertext transfer protocol secure
IP—internet protocol
LAN—local area network
SID—USPD or user streaming-player App identification information
PC—Personal Computer
VPN—virtual private network
WAN—wide area network
WWW—World Wide Web
Content—includes audio files such as music, talking books, news and the like, video such as movies and music video clips and automation sequences that may be synchronized with playback of the audio and video
Programmer—a person that uses a programmer terminal to define the playlist, the playback schedule and associated automation actions for one or more USPDs for the enjoyment of the associated users
User(s)—one or more persons using a USPD to enjoy the play-back of the content as programmed by the programmer.
Real time Streaming Protocol (RTSP) is an example of a streaming protocol.

### SUMMARY OF THE INVENTION

In one aspect, the invention seeks to address one or more of the foregoing problems or limitations.

It is desirable to provide a system and method which enables individuals (users) who would otherwise be unable to access content from the internet or other networks, to enjoy access to this content with the assistance of a second party (programmer), by allowing the second party (the programmer) to select the content and arrange for it to be played for the benefit of the end user by an end user device.

The invention can be adapted to provide access to content substantially independent of the user device being used, in a way that requires minimal or no intervention by the individual user receiving the content.

The invention can be adapted to enable the setup of social groups (multiple users) to access common content as programmed by the social group coordinator (programmer) who, in one embodiment, may also be the content owner. This essentially enables the setting up of narrowcast or even target-cast groups to consume specialized content.

A further benefit of the invention is the ability of a programmer to remotely pre-load content into the users' devices, which may comprise of operating instructions including, but not limited to, movement instructions to internet-connected (Internet of Things) devices, such as robots, which the users' devices proceed to carry out as scheduled by the programmer in a manner that may be synchronized with the content being played by the users' devices.

In a further adaptation, the invention can be adapted to enable synchronized play-back of content on a plurality of devices.

This can include concurrent playback on multiple independent users' devices as well as coordinated playback wherein the playback comprises multiple segments each played by one or more independent devices such that each playback device plays a pre-assigned segment by itself or in conjunction with additional devices.

According to an embodiment of the invention, there is provided a content retrieval control system including:
a management center;
programming capability; and
one or more managed terminals; wherein
the managed terminals are connectable to one or more content repositories; the content retrieval control system includes one or more association registers associating each managed terminal with the programming capability;
the content retrieval control system includes one or more programmable content delivery schedules for each managed terminal adapted to store content identification information identifying selected content;
the programming capability is adapted to program the content delivery schedules with content identification information identifying content in one or more of the content repositories for each managed terminal with which the programming terminal is associated;
the management center is adapted to deliver the content delivery schedules including content identification information to each corresponding managed terminal;
each managed terminal is adapted to use the content identification information to retrieve content identified by the content information from a content repository.

The content retrieval control system can include one or more programming terminals.

The content identification information can include the access addresses for selected content at a content repository.

The content identification information includes associated content retrieval time information.

The management center is adapted to facilitate the delivery of home automation information to one or more managed terminals.

Each managed terminal can be adapted to receive home automation information.

Each managed terminal can be adapted to retrieve home automation information from a content repository.

According to an embodiment of the invention, there is provided a method of retrieving content from one or more content repositories by one or more managed terminals, the method including the steps of:
programming content retrieval schedules with content identification information identifying selected content in one or more of the content repositories for each managed terminal;
delivering the content identification information to each corresponding managed terminal;
using the content identification information to retrieve selected content identified by the content identification information from a content repository.

According to an embodiment of the invention, there is provided a managed device adapted to: receive content identification information; retrieve selected content from content repository using the content identification information; convert content received from a content repository to a human comprehensible format, the managed device including:
a first processor;
at least first communication interface;
at least a first output generator;
a content information store;
wherein
the first communication interface is adapted to interface the managed device to a communication network,
the first output generator is adapted to generate an output in human-comprehensible format,
and wherein
the processor is adapted to:
store content identification information identifying selected content in a content information store,
retrieving at least part of the selected content from an on-line content store;
convert the selected content to a human-comprehensible format by an output generator.

The selected content can be streaming content.

The managed terminal can be adapted to receive home automation instructions and to send the home automation instructions to one or more controllable devices.

The managed terminal can be adapted to retrieve home automation instructions and to send the home automation instructions to one or more controllable devices.

The managed device can include one or more user interfaces, at least one of which includes gesture recognition capability.

According to an embodiment of the invention, there is provided a method of loading operating instructions into a network-connected operable device from a network-connected programmable control device including the steps of: using the programming device to retrieve instruction identification information from an instruction server, forwarding the instruction identification information to programmable control, and initiating the download of corresponding instructions from the instruction server to the programmable control device, and using the downloaded instructions to control an actuator or servo device.

According to an embodiment of the invention, there is provided a programming terminal adapted to program the retrieval of selected content by one or more managed terminals, the programming terminal including:
a management center user interface adapted to display and program a managed terminal association register identifying each managed terminal with which the programming terminal is associated;
the managed terminal association register identifying preferences for each managed terminal;
wherein the programming terminal is adapted to register preferences for each managed terminal with a management center adapted to deliver the preferences and content identification information to each managed terminal.

The programming capability can reside in the programming terminal, the management center, or partially in both and may include a component resident in the managed terminal.

The preferences can include content identification information.

The preferences can include content retrieval time information.

According to an embodiment of the invention, there is provided a management center for a content retrieval system, the management center including:
a first communication interface adapted to enable communication between one or more programming terminals and the management center;
a second communication interface adapted to enable communication between the management center and one or more managed terminals;
a register associating each programming terminal with one or more managed terminals;
a programmable content retrieval schedule for each managed terminal controlled via the associated programming terminal;
wherein the management center is adapted to transmit a corresponding content retrieval schedule to each managed terminal.

### BRIEF DESCRIPTION OF THE DRAWINGS

An embodiment or embodiments of the present invention will now be described, by way of example only, with reference to the accompanying drawings, in which:

FIG. 1 is a diagram illustrating basic elements of a network architecture according to an embodiment of the invention.

FIG. 2 is a diagram illustrating examples of connectivity aspects according to an embodiment of the invention.

FIG. 3 illustrates examples of software processes associated with the manager subsystem according to an embodiment of the invention.

FIG. 4 illustrates examples of software processes associated with the USPD according to an embodiment of the invention.

FIG. 5 illustrates a flowchart associated with the process followed by an individual registering on the system as a programmer according to an embodiment of the invention.

FIG. 6a illustrates a flowchart showing examples of the actions available to a programmer registered on the system according to an embodiment of the invention.

FIG. 6b illustrates a flowchart associated with the process followed by a programmer when registering one or more USPDs with the system according to an embodiment of the invention.

FIG. 6c illustrates a flowchart associated with the process followed by a programmer when nominating content to be streamed to the one or more USPDs according to an embodiment of the invention.

FIG. 7A illustrates the structure of the database maintained in the manager subsystem according to an embodiment of the invention.

FIG. 7B illustrates the structure of a register maintained in the USPD of available notification channels according to an embodiment of the invention.

FIG. 7C illustrates the structure of a register maintained in the USPD defining notification messages and the one or more channels used deliver the notification messages resulting from a change of state of one or more USPD wired or wireless sensors according to an embodiment of the invention.

FIG. 8 illustrates the message flow between various elements of the invention associated with streaming of content to a USPD according to an embodiment of the invention.

FIG. 9 illustrates the operation of a web-browser as used by a programmer according to an embodiment of the invention.

FIG. 10 illustrates the format of a message from the manager to the USPD used to nominate the content to be streamed and schedule a time for the streaming to commence as nominated by a programmer according to an embodiment of the invention.

FIG. 11 illustrates functional aspects of a USPD designed to resemble a child's toy according to an embodiment of the invention.

FIG. 12 illustrates a functional block diagram of the processor and associated interfaces associated with a USPD designed to resemble a child's toy according to an embodiment of the invention.

FIG. 13 illustrates a functional block diagram of the powering aspects associated with a USPD designed to resemble a child's toy according to an embodiment of the invention.

FIG. 14 illustrates a method of mounting a USPD designed to resemble a child's toy in a charging cradle according to an embodiment of the invention.

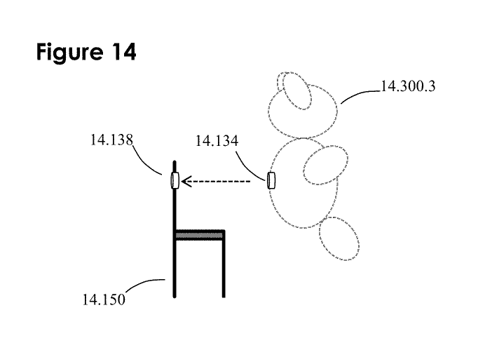

FIG. 15 illustrates an embodiment of a USPD in the form and capabilities of a robot, including motors and actuators used under program control independent of or in conjunction with other content according to an embodiment of the invention.

FIG. 16 illustrates the layout of a user interface that allows a programmer to associate automation functionality with the nominated content according to an embodiment of the invention.

FIG. 17 illustrates the form of an XML file used to send automation instructions to a USPD according to an embodiment of the invention.

FIG. 18 illustrates the data exchange between the USPD and a network based speech recognition engine used to provide the user with speech-based control of the USPD according to an embodiment of the invention.

FIG. 19 illustrates an arrangement adapted to control home automation devices according to an embodiment of the invention

The drawings are intended to illustrate the inventive features of the embodiments illustrated and are not necessarily to scale. The orientation of the drawings is chosen to illustrate the inventive features and is not necessarily indicative of the orientation of the device in use. The symbols used to indicate the various items are not actual representations of the physical appearance of the items.

### DETAILED DESCRIPTION OF THE EMBODIMENT

The invention will be described with reference to the embodiments illustrated in the accompanying drawings.

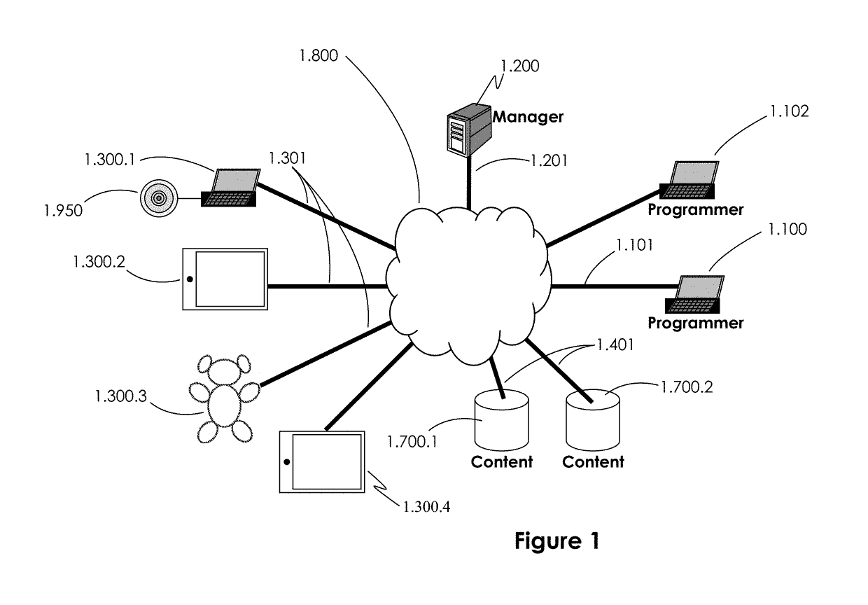

FIG. 1 shows a content distribution network according to an embodiment of the invention.

The system shown in FIG. 1 includes one or more programming terminals 1.100, 1.102, a network manager or management center 1.200, one or more content repositories 1.700.1, 1.700.2, and one or more USPDs, 1.300.1, 1.300.2, 1.300.3, 1.300.4, interconnected via a communication network such as the internet 1.800. The USPDs are configured by the programmer terminals (1.100 and 1.102) via the system manager (1.200) to enable the USPDs to access the content repositories such as 1.700.1, 1.700.2 via the internet (1.800).

More particularly, the network includes elements such as:

Item 1.100—a PC used by a programmer to add USPDs such as 1.300.1, 1.300.2, 1.300.3 and 1.300.4 to their personal network or virtual network and to configure the USPDs to access content, including multiple USPDs concurrently accessing the same content based on a programmer nominated schedule, from one or more content providers (1.700.1 and 1.700.2) connected to the internet to be streamed via the internet (1.800) to the one or more designated USPDs (1.300.1, 1.300.2, 1.300.3 and 1.300.4). While a PC is shown as being used by the programmer, a smart device, such as a tablet or smart phone can also be used.

Item 1.102—a PC used by a programmer—this serves to illustrate that the invention supports multiple programmers (1.100 and 1.102) associated with one USPD and that multiple USPDs such as 1.300.1, 1.300.2, 1.300.3 and 1.300.4 can be associated with one programmer. As noted above the programmer can also use a tablet or smart phone.

Item 1.300.1—a USPD implemented as a PC connected via the internet to the network setup by one or more programmers (1.100 and 1.102). In one embodiment the PC 1.300.1 executes a user streaming-player application in a web browser. One or more of the programmer terminals 1.100, 1.102 can interact with the user streaming-player application on the PC (1.300.1) to manage the streaming player application through the PC's internet connection (1.301) via the manager server 1.200 as detailed below.

Item 1.300.2—a USPD implemented on a smart phone or tablet device connected via the internet (1.800) to the network setup by one or more programmer terminals (1.100 and 1.102). In one embodiment the smart phone or tablet device (1.300.2) executes the user streaming-player application in an App supplied pre-loaded on the device or downloaded from known internet-based App repositories.

Item 1.300.3 is a USPD implemented in a purpose made device such as a toy or internet radio connected via the internet (1.800) to the manager (1.200). In one embodiment the USPD is supplied to the user pre-loaded with the user streaming-player application.

Item 1.700.1 represents a content storage location accessible via the internet (1.800) able to stream content to one or more USPDs which may be user streaming-player applications

Item 1.700.2 represents a content storage location accessible via the internet (1.800) able to stream content to one or more USPDs which may be user streaming-player applications. It is used to illustrate the ability of the invention to support multiple USPDs accessing multiple content sites via the internet.

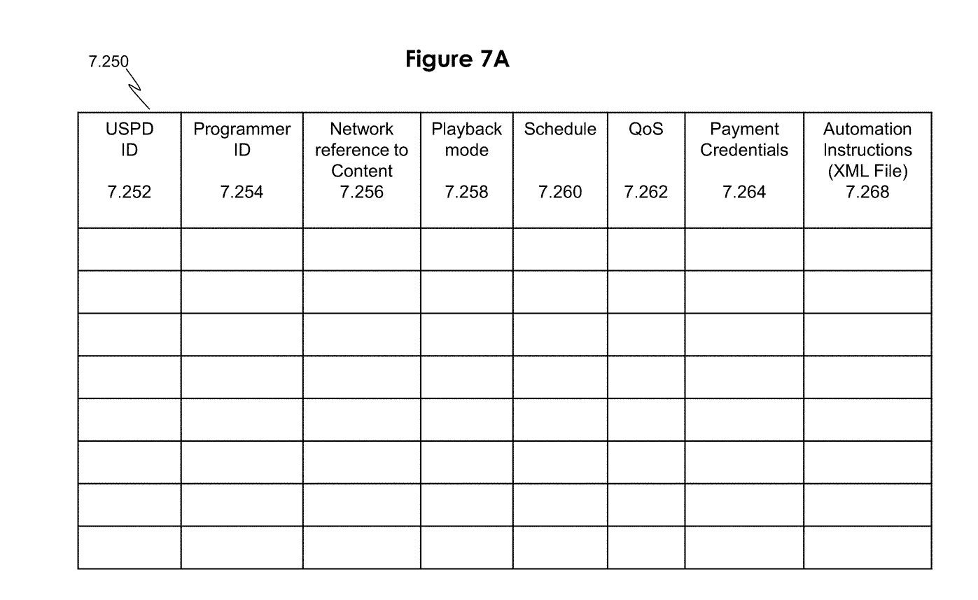

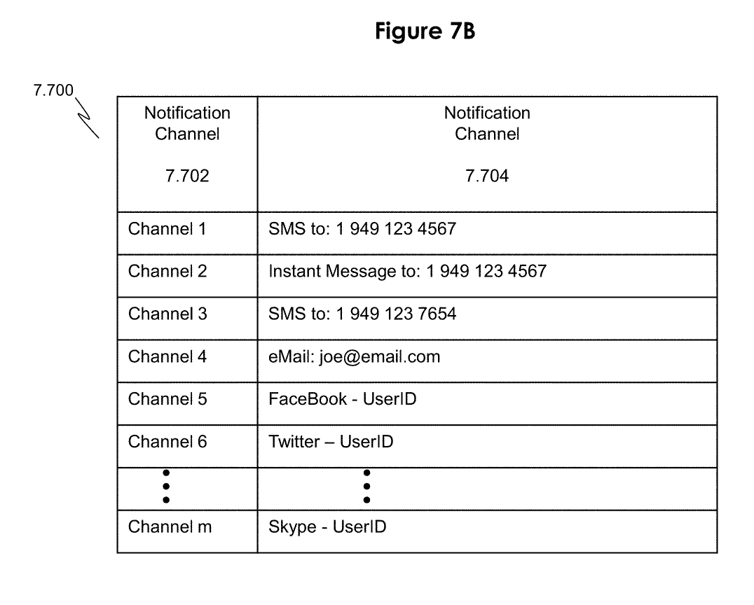

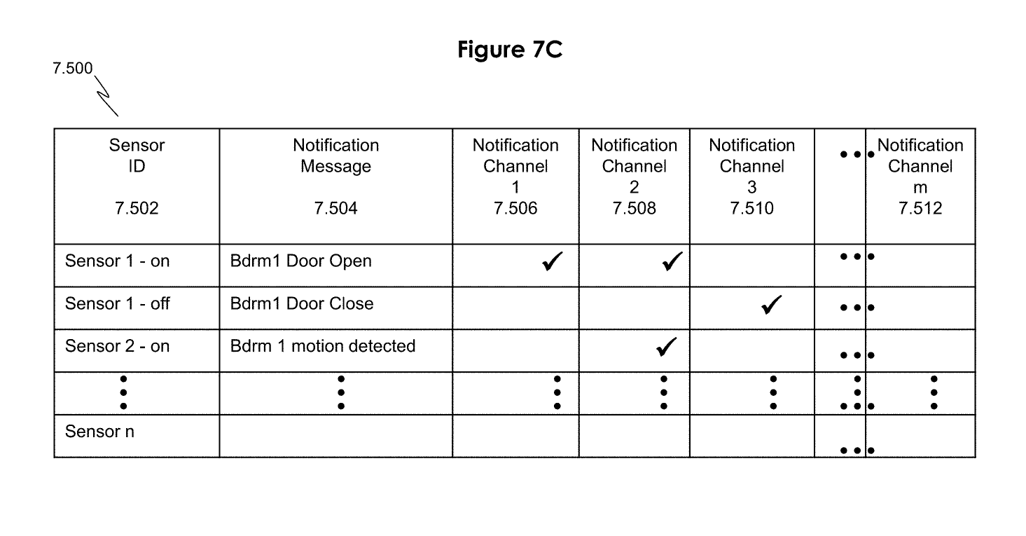

Item 1.200 is the network manager. The manager (1.200) may be implemented as software applications operating on one or more servers connected to the internet, which may be virtual servers and may be associated with a content provider such as 1.700.21 or 1.700.2. The manager is also associated one or more databases (2.200.1). It maintains a register (see FIG. 7) of one or more USPDs such as 1.300.1, 1.300.2, 1.300.3, 1.300.4, which it configures, based on programmer input (1.100 and 1.102), monitors and manages. The manager (1.200) also maintains a register of programmer terminals (1.100 and 1.102), and the association between programmer terminals and USPDs, as well as the content, schedule and play-back conditions nominated by one or more programmer terminals for each associated USPD. The network manager provides remote management of the USPDs (1.300.1 etc.). This may include receiving status updates, which may be initiated by the state transition of the one or more sensors associated with the USPD (1.300.1 etc.), and may also include the identification that the USPD (1.300.1 etc.) is off-line by detecting the state of the IP tunnel such as 2.310.1 or 2.310.1b, storing the status update in the database (3.220) associated with the manager (1.200) and when the associated programmer (1.100, 1.102) is logged on to the manager (1.200), forwarding the status update to the programmer (1.100 etc.) for display. The manager (1.200) is accessed by one or more programmer terminals (1.100, 1.102) that can be used to associate USPDs such as 1.300.1, 1.300.2, 1.300.3 and 1.300.4 to the programmer's personal network and to configure the USPDs to initiate the streaming of content via the internet (1.800) from one or more content providers (1.700.1 and 1.700.2) to the one or more USPDs (1.300.1, 1.300.2 and 1.300.3) and to nominate automation, such as home automation action sequences such as controlling lights in a manner that may be synchronized with the playback of the content.

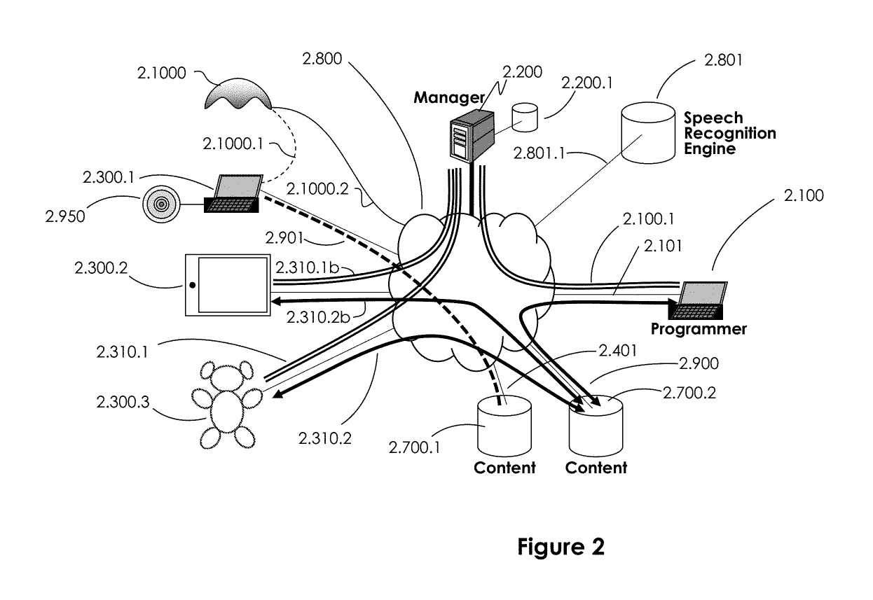

As shown in FIG. 2, two or more managed terminals (2.300.2, 2.300.3) can be adapted to retrieve the same content from a content server such as 2.700.2 at the same time when each managed terminal receives the content address and implementation timing instructions from manager 2.200. For example, managed terminals 2.300.3 and 2.300.2 can receive the same content address information from manager 2.200 via VPN tunnels 2.310.1, 2.310.1b respectively. This enables the managed terminals to retrieve the content via corresponding IP connections 2.310.2 and 2.310.2b. Of course, the expression “at the same time” should not necessarily be restricted to strict simultaneity, as there may be differing system delays between the terminals and the content server. Nevertheless, this capability enables two or more users to receive the same content on their managed terminals at the same time.

Item 1.800 represents the internet. While the invention operates over any IP data network, the preferred embodiment described herein assumes that the internet is the data network being used.

The items described above are connected to the internet (1.800) via various data links which may include Ethernet, frame relay, ADSL, cable modem, optical fiber, cellular, such as LTE, 3G, 4G, 5G and WiFi etc. identified in the Figure as items 1.101, 1.201, 1.301 and 1.401.

FIG. 2 details the operation of the invention. Following registration (covered below), the programmer (2.100) has access to one or more USPDs (2.300.1, 2.300.2, 2.300.3) that have been registered by the programmer with the manager (2.200) and have been associated with the programmer's (2.100) account.

The programmer (2.100) logs on to the manager (2.200) using a suitable device such as a PC, smart phone or tablet. The programmer (2.100) connection to the manager (2.200) can be via a secure IP tunnel (2.100.1) over the programmer's internet connection (2.101). This connection may be using OpenVPN, SSL, HTTPS and the like to ensure data security.

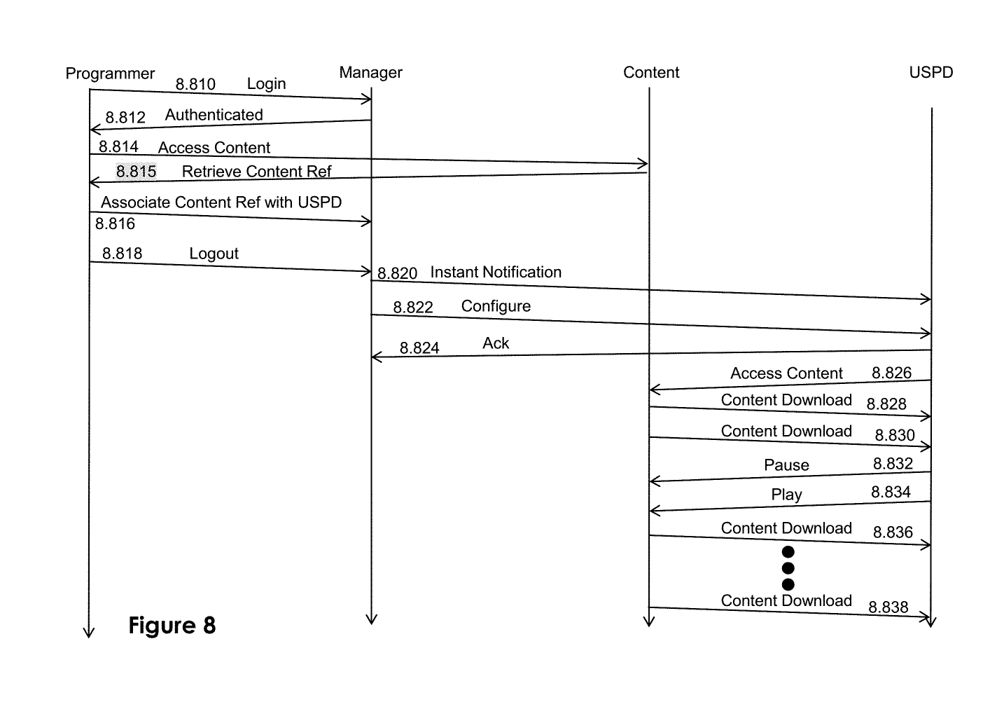

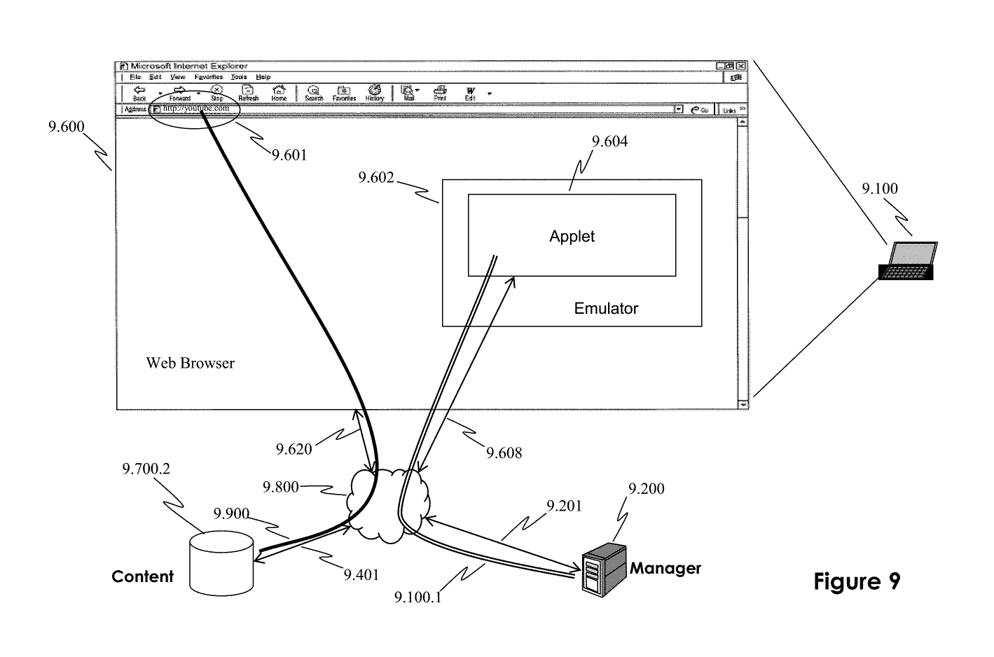

A programmer (2.100) may interface to the manager (2.200) using a known web browser as illustrated in FIG. 9 (9.600) that supports known emulator capabilities (9.602) able to execute known software commands commonly referred to as an Applet or browser extension (9.604). The web browser executed Applet code (9.604) maintains connectivity with the manager (9.200) while the programmer (9.100 and 2.100) defines a playlist by setting up internet connections (2.900) to one or more URLs or IP addresses which uniquely identify the selected content in a content repository (e.g., 2.700.2) to be streamed to the one or more nominated USPDs (2.300.1, 2.300.2, 2.300.3). The content repository 2.700.2 may contain one or more content items each with a unique URL. The programmer (2.100) uses the Applet (9.604) to nominate the one or more USPDs (2.300.1, 2.300.2, 2.300.3) and the conditions under which the USPDs will commence streaming and playing the content defined by the URL that the programmer (9.100) is accessing using the web browser (9.601). The process for establishing the streaming of content (2.310.2) by the USPD (2.300.3) from the content repository (9.700.2) is described below with reference to FIG. 8.

The invention can also be adapted to allow content already owned by the user or the programmer to be streamed. This content may be stored on a device such as a PC hard-drive (HDD) or on a DVD (1.950) on a device associated with the user or programmer such as PC 1.300.1. The content associated with the user or programmer may also reside at an off-site location, for example cloud-based storage such as Dropbox™ and the like and be accessed in a manner determined by the programmer (2.100). This is illustrated as a drive accommodating CD or DVD based content (2.950) connected to a personal computer (2.300.1) which establishes a secure connection (2.901) via the internet to a cloud-based storage site (2.700.1) which is connected to the internet (2.800) via a data connection (2.401) in order to upload and store the content for later access. Content can be uploaded from the programmer terminal (2.100) to a cloud-based storage site (2.700.1) in the same manner.

The USPD configuration data entered by the programmer (2.100) is stored in the manager database (2.200.1) in a database record associated with the programmer (2.100) as shown in FIG. 7 (7.250). The USPD configuration data includes various playback parameters and can nominate which if any of the USPD connected sensors, including wireless sensors (12.122) should trigger a status update to be sent via the manager (3.206) to the programmer (3.100).

The USPD, for example 2.300.3 maintains an always-on secure IP tunnel (2.310.1) to the manager (2.200) over its internet access link (1.301) using IP tunnel messaging protocols which implement encrypted secure access methods such as SSL, HTTPS or OpenVPN. Use of an IP tunnel (2.310.1) by the USPD (2.300.3) avoids the need for the user to modify the firewall setting on their broadband router. The IP tunnel (2.310.1) between the USPD (2.300.3) and the manager (2.200) is used by the manager (2.200) to configure, including the downloading of playlists, manage and monitor the operation of the USPD (2.300.3) and to inform the programmer (2.100) of the status of the USPD (2.300.3) including whether it is on-line, and whether it is streaming content.

The manager (2.200) is able to analyse the playlists and schedules generated by the programmers (2.100) using the network in order to collect information, including user viewing habits, which can be analysed by the manager (2.200) or another computer system at a later stage to be used to propose playback lists or to identify relevant products and services to promote to the one or more users.

An always-on connection is one in which, following a drop-out of the connection, the device or devices supporting the always-on connection automatically attempt to re-establish the connection.

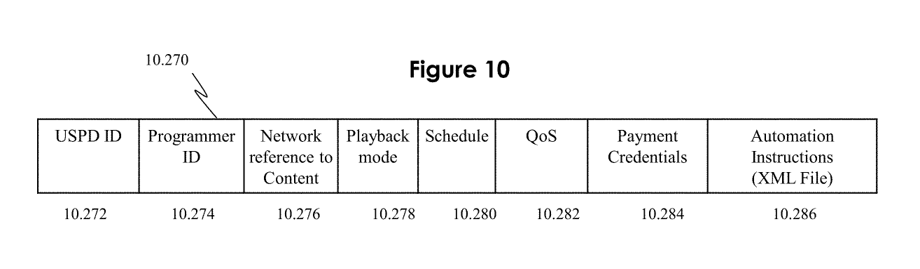

The manager (2.200) uses the secure IP tunnel (2.310.1) to download into the USPD (2.300.3) the URL or other unique network addressing means associated with the content nominated by the programmer and other information including automation control using a message format shown in FIG. 10 (10.270). A more detailed message exchange between the manager and the USPD is provided in FIG. 8 and is further described below.

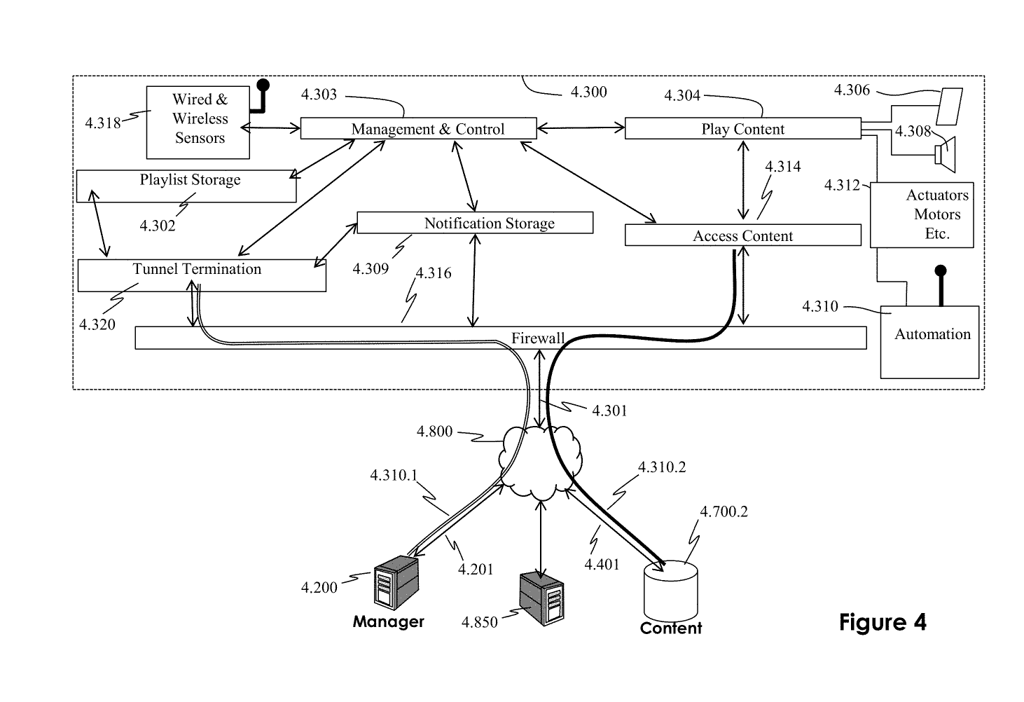

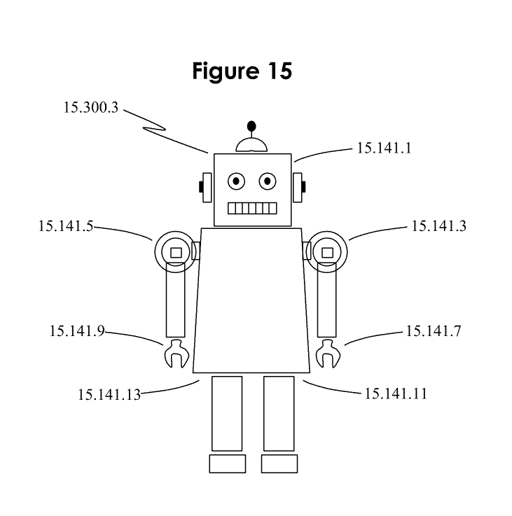

When the manager (2.200) has downloaded the necessary information to the USPD (2.300.3), and at the time scheduled by the programmer (2.100) and with the programmed conditions (e.g. automatic play or user triggered), the USPD software shown in FIG. 4 accesses the nominated content address or URL and proceeds to stream the content (2.700.2) via an internet connection (2.310.2) and play it using one or more of its interfaces including speaker (4.308), screen (4.306), home automation network interface (4.310) which controls and monitors home automation devices using known home automation networks including Z-Wave, Zigbee and WiFi, as well as actuators and motors (4.312) as in the case of the robot embodiment of the USPD (FIG. 15) or domestic appliances allowing the content playback to be associated with the movement of the USPD or control of home automation devices such as lights, heating, etc.

A further improvement in the user experience is achieved by implementing voice recognition in the USPD. While this functionality may be implemented using software in the USPD, an alternative embodiment is the use of a centralized voice recognition processor (2.801) connected to the internet (2.800) via access link 2.801.1 such that a USPD (2.300.1, 2.300.2 and 2.300.3) digitally captures or records the voice, which may include commands issued by the user and passes the audio to the centralized voice recognition processor (2.801) for interpretation thereby reducing the complexity and cost of the USPD. This capability may be used as a children's educational aid such as for language acquisition whereby the right response by the child is automatically identified and rewarded, by for example, the toy performing a short dance or activating various devices. The speech recognition engine 2.801 can also be used to activate devices such as motors, servo-motors and actuators at the user's premises under voice commands from the user. Thus the user can control household appliances and apparatus such as pool pumps, windows, blinds, etc., using, for example, WiFi connected controllers in communication with the USPD (2.300.3).

Where the USPD is implemented as a screen-based device, such as a smart phone, tablet or personal computer (PC), the content may be displayed within a frame surrounded by a border area, where the border area is used to display advertisements that are deemed to be relevant to the user as determined by the user's viewing habits. The advertisements may be stored in the manager (2.200) or other servers connected to the internet (2.800) and are treated by the USPD as content and are streamed as described above.

In addition, the users may elect to post comments on the material that they have viewed or listened to. These comments may be directed to the programmer (2.100) or shared with the other users. These comments may be provided using voice recognition as discussed above, or may be typed into a data entry field on the display and sent to the manager (2.200) over the IP connection, such as 2.310.1.

The system of FIG. 2 can also include a gesture recognition device 2.1000 which may be connected to the manager and/or content resource directly via the communication network 2.800 via access link 2.1000.2, or the gesture recognition device can be associated with a USPD such as 2.300.1 and be connected via USB or other electrical interface (2.1000.1) or incorporated in a USPD such as for example 2.300.3 and used to control device operation including playback.

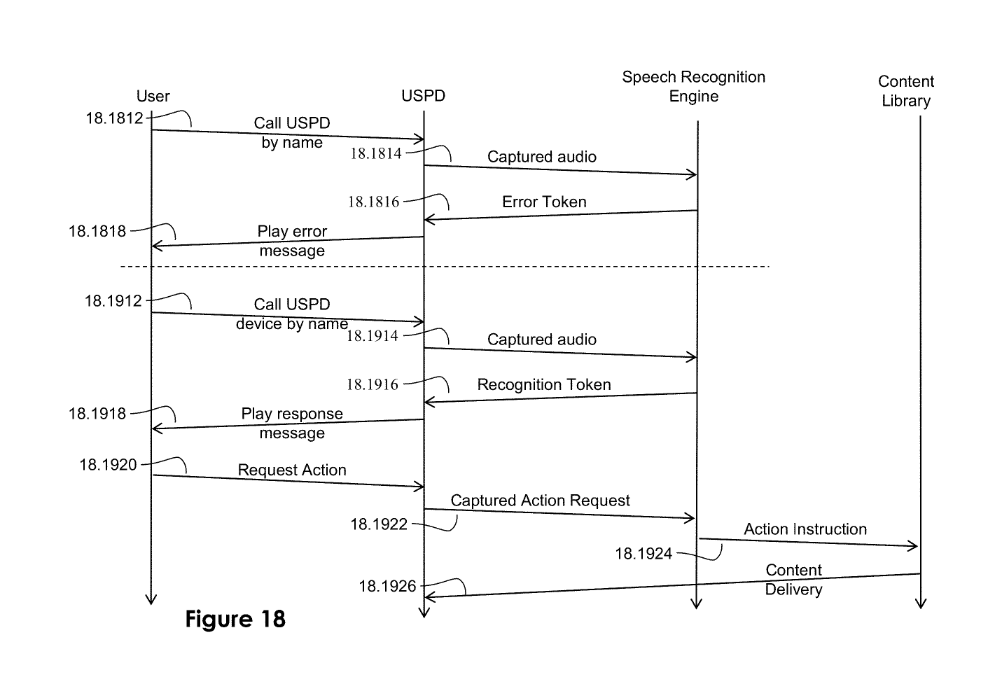

FIG. 18 illustrates the operation of the voice recognition functionality further covered below. The USPD (2.300.3) is equipped with one or more microphones (11.334) which capture the user's spoken commands or responses. The resultant data is streamed to the voice recognition engine (2.801) via the internet (2.800).

While the above description details the operation of the invention when the programmer (2.100) uses a third-party web browser (9.600) to communicate with the manager (2.200), it would be clear to one skilled in the art that an App, being a dedicated computer program executing on a smart phone or tablet adapted to interface to the manager and provide similar functionality to the web browser, can also be used.

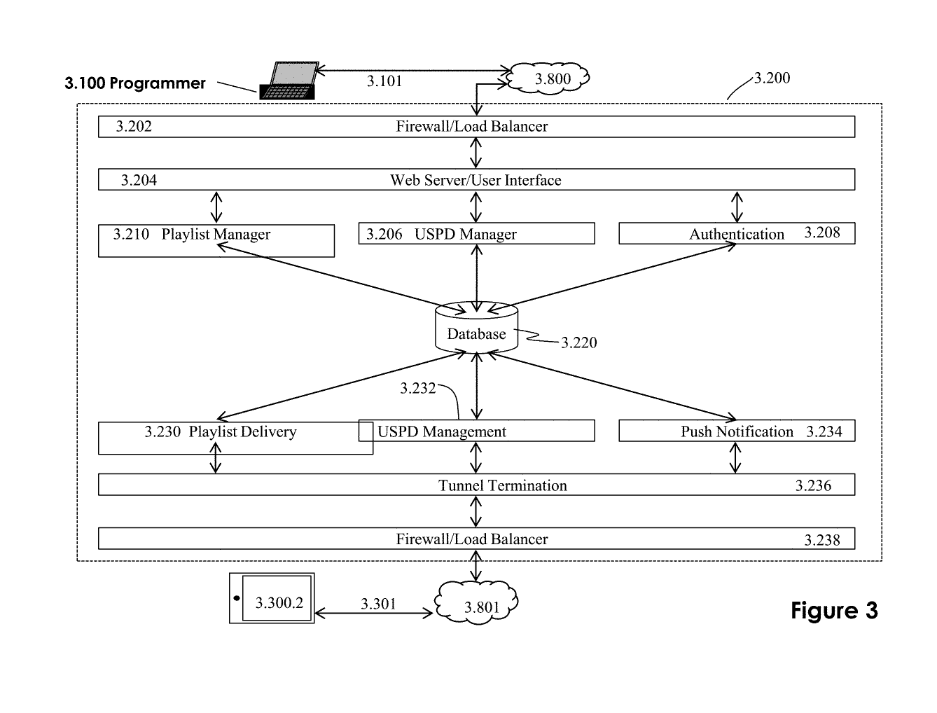

FIG. 3 details the software functional blocks associated with the manager (2.200).

The manager (3.200) comprises software functional elements that allow it to be implemented on computer servers and routers or on virtual servers such as in a known ‘cloud’ environment.

The programmer (3.100) connects to the manager (3.200) via the internet (3.800) through an access link (3.101) such as LTE, ADSL and the like using a secure encrypted data connection such as HTTPS. The data connection terminates on a firewall/load-balancer functional block (3.202). This functional block filters the incoming traffic to ensure that only valid traffic enters the server thereby minimizing the opportunity for hackers to deleteriously impact the operation of the system by sending rogue traffic. In addition, where there are two or more servers, the load-balancer is used to evenly distribute the incoming traffic among servers in order to avoid overloading some servers and to support the upscaling of the manager to support a large number of programmers (3.100) and USPDs (3.300.2).

IP traffic filtered by the firewall (3.202) originating from the programmer (3.100) terminates on the Web Server User Interface (3.204) which provides a local or remote programming interface. When programmer access is via the internet, the web server servers the login page, allowing a programmer (3.100) to log on to the manager (3.200). The programmer's (3.100) login credentials are authenticated by the Authentication functional block (3.208) which verifies the credentials entered by the programmer (3.100) against those held in an encrypted manner in the database (3.220).

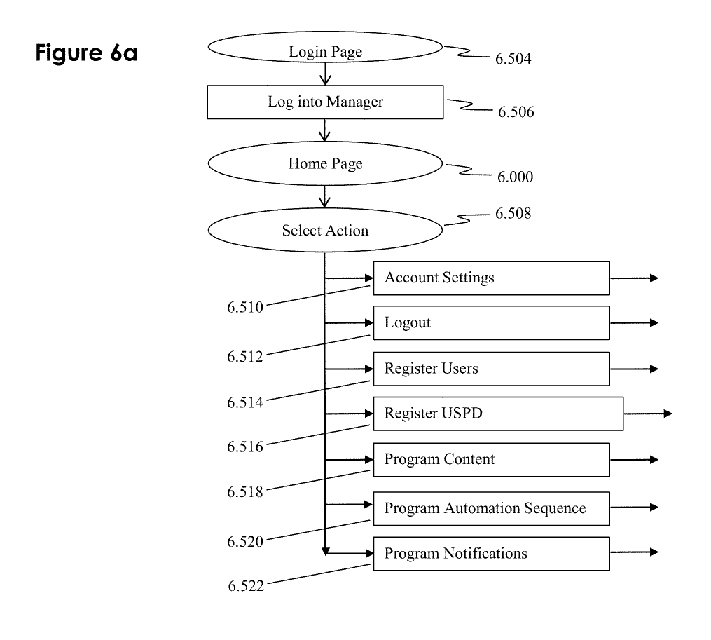

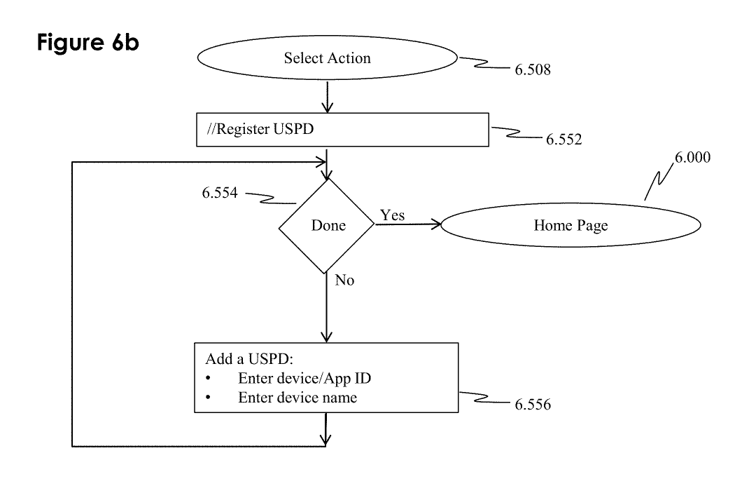

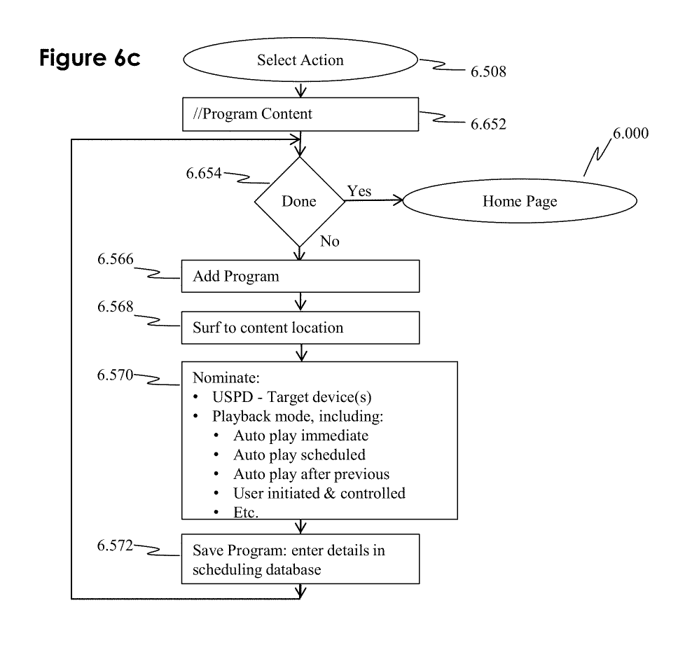

Once the programmer's (3.100) login credentials are authenticated, the web server (3.204) serves the home page (6.000 in FIG. 6a) which represents the beginning of a programming session. During this session the programmer (3.100) can setup a playlist via the Playlist Manager (3.210) which is associated with one or more USPDs (3.300.2). The resultant playlist is stored in the database (3.220).

The USPD Manager (3.206) allows the programmer (3.100) to manage various aspects of the USPD (3.300.2), such as checking connectivity, updating software version and configuring various playback parameters and nominating which if any sensors should trigger a status update to be sent via the manager (3.206) to the programmer (3.100). This updated configuration information is recorded in the database (3.220) and passed on to the USPD Management subsystem (3.232) to update the USPD (3.300.2) via the internet (3.801) and the USPD's internet connection 3.301.

A playlist delivery subsystem (3.230), a USPD management subsystem (3.232), and a push notification subsystem (3.234) communicate with the USPDs such as 3.300.2 via tunnel termination (3.236), second firewall/load balancer (3.238), and the internet (3.801). It is understood by one skilled in the art that the first firewall/load balancer (3.202) and the second firewall/load balancer (3.238) may be implemented in the same physical unit.

The Playlist Delivery subsystem (3.230) is used to update the selected USPDs (3.300.2) with the latest playlist.

The Push Notification subsystem (3.234) is used to notify the one or more affected USPDs and the associated user or users, that the USPD (3.300.2) has been configured with a new playlist.

While the internet connection (3.800) between the manager (3.200) and the programmer (3.100) is shown separately to the internet connection (3.801) between the manager (3.200) and the USPD (e.g. 3.300.2) it is understood that the networks represented as (3.800) and (3.801) are generally the same network.

Each USPD (3.300.2) establishes an always-on IP connection via an encrypted IP tunnel (see 2.310.1) over the internet (3.801) to the manager (3.200). The encrypted IP tunnel (2.310.1) passes through the firewall/load-balancer functional block (3.238) which is used to filter out unwanted IP traffic and to share the processing load between servers which also allows additional servers to be added to increase the capacity of the manager to handle an increasing number of connections from USPDs. The encrypted IP tunnel (2.310.1 in FIG. 2) between the USPD (3.300.2) and the manager (3.200) terminates on the Tunnel Termination subsystem (3.236). Communications between the manager (3.200) and USPDs (3.300.2) generally use always-on encrypted tunnels such as OpenVPN or IPsec.

It is clear to one skilled in the art that a component of the programming function may also reside in the USPD (3.300.2). Direct programmer (3.100) access to the USPD (3.300.2) is supported through the manager (3.200) whereby the manager (3.200) is providing a bi-directional routing function routing traffic from the programmer (2.100) to manager (2.200) over IP tunnel (2.100.1) on to the manager (2.200) to USPD (2.300.2) IP tunnel (2.310.1).

FIG. 4 details the functional subsystems associated with the implementation of the USPD (4.300).

The USPD (4.300) is connected to the internet (4.800) via local access means (4.301) including wired and wireless (cellular, WiFi, Ethernet and the like). The firewall (4.316) is implemented to block unwanted IP traffic.

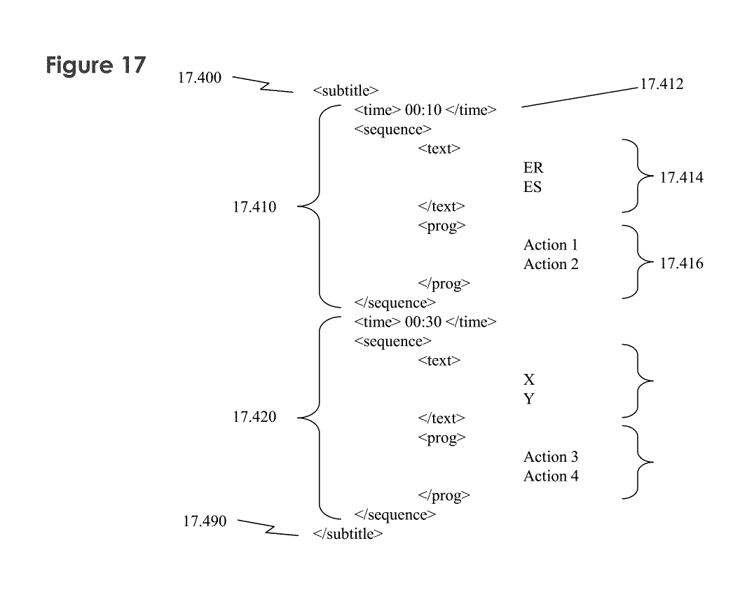

The Tunnel Termination subsystem (4.320) establishes and maintains the always-on IP tunnel (4.310.1) over the manager's internet access link (4.201) to the manager (4.200) which is used to provide secure communications between the USPD (4.300) and the manager (4.200). This tunnel (4.310.1) allows the manager (4.200) to deliver one or more playlists to the USPD (4.300) as instant messages (8.822) which are stored in the USPD's memory (12.126.1 and 12.126.2) by the USPD's Playlist Storage subsystem (4.302). A playlist is generated by the manager (4.200) from information stored in its database by the programmer (1.100) as shown in FIG. 7 and may include home automation sequence instructions using XML format as shown in FIG. 17 or other suitable formats including JASON. The playlist contains one or more addresses or locations from which content can be accessed, which may be on the internet, and that can be accessed using a URL or an IP address and may include timing-based automation instructions. The USPD (4.300) streams and plays the content as scheduled by the programmer (2.100) and configured by the manager (4.200) by carrying out the instructions sent to the USPD (4.300) by the manager (4.200) using the message format shown in (FIG. 10).

An alternative embodiment is for the manager (2.200) to stream the selected content from the content provider (2.700.2) and to forward it to the one or more USPDs (2.300.1, 2.300.2, 2.300.3 etc.) rather than to have the USPDs (2.300.1, 2.300.2, 2.300.3 etc.) directly access the content from the content provider (2.700.2) using the address of the content supplied to the USPD (2.300.3) by the manager (2.200). This alternative embodiment requires the manager (2.200) to re-stream the content from the content provider (2.700.2) to the one or more USPDs (2.300.1, 2.300.2, 2.300.3 etc.) using the existing format of the content or by translating the stream into another format, such as remote desktop. This embodiment has the benefit of reducing the complexity of the software implementation of the USPDs (2.300.1, 2.300.2, 2.300.3 etc.) but at the potential cost of greater traffic at the manager (2.200) as well as the need for the manager (2.200) to buffer content.

At the scheduled time the USPD Management and Control module (4.303) initiates the streaming of content by accessing the Playlist Storage subsystem (4.302) and transferring the address of the next item on the playlist to the Access Content subsystem (4.314). The Access Content subsystem (4.314) establishes a connection (4.310.2) to the site containing the content (4.700.2) and proceeds to stream the content to the Play Content module (4.304). The connection to the site containing the content (4.700.2) is made through the internet (4.800) using the one or more internet connections (4.301) available to the USPD. The site containing the content (4.700.2) is connected to the internet (4.800) via a data connection (4.401).

The streamed content is passed on to the Play Content subsystem (4.304) which outputs it via the appropriate interface devices such as screen (4.306), speaker (or headphones) (4.308).

Simultaneously with the playback of the streamed content, the Play Content subsystem (4.304) executes the instructions contained in the associated XML file (FIG. 17) and drives the home automation devices (4.310) which can provide, for example, control of the environment (lights, blinds etc.) using known wired home automation devices and wireless home automation devices using wireless networks such as Z-Wave, WiFi and the like.

The home automation instructions may be sent to the USPD by the manager (FIG. 10) or may be accessed by the USPD together with the streamed content.

The Management and Control subsystem (4.303) allows the manager (4.200) to modify the configuration of the USPD (4.300) by actions such as downloading new software or changing playback parameters.

The USPD may also be configured with actuators and motors (4.312) allowing it to move or directly control devices as part of the playback. This is controlled by the automation instructions file (FIG. 17) that the programmer can associate with the content being streamed.

In a further embodiment, the USPD can be adapted to retrieve the content from the content repository and store it for later playback in the Playlist Storage area (4.302).

The USPD (4.300) may also be provisioned with wired and wireless sensors (4.318) which may be configured by the programmer to provide a number of functions, including to control the playback of content, to sense the environment around the USPD, including light-level and movement. These sensors can be programmed to control the manner in which the Play Content module (4.304) executes the instruction stream. In addition, the programmer may associate with the activation or de-activation of the wired and wireless sensors (4.318) notifications to the one or more user associated with the USPD (4.300).

FIG. 7B illustrates the user reporting channel register (7.700) that may be associated with the wired and wireless sensors (4.318). The programmer, via the manager associates each active reporting channel (7.702) with one unique message delivery service (7.704) such as SMS, email, Skype™ etc.

FIG. 7C illustrates the register (7.500) used by the programmer via the manager to form the association between sensor state changes with user notification channels. Column 7.502 has an entry for each sensor and the state that the sensor can be in. For example, sensor 1 is on when the bedroom1 door is open and sensor 1 is off when bedroom1 door is closed. Column 7.504 details the message sent the user via the nominated channel. The message is used to alert the user of an occurrence associated with the sensor and may include text and emoji's. Columns 7.506, 7.508, 7.510, 7.512 etc. are used to associate the notification with each of the available delivery channels as defined in FIG. 7B.

The programmer (1.100) forms the associations in FIG. 7B and FIG. 7C via the manager (1.200) by entering the required details into the web portal (FIG. 9) or App which populates the associated data table in the Notification Storage (4.309) module in the one or more USPD being configured. When triggered by a wired or wireless sensor (4.318), the USPD Notification Storage (4.309) module sends the notification defined in the table shown in FIG. 7C via the internet (4.800) to the selected services, such as email (4.850) and the like.

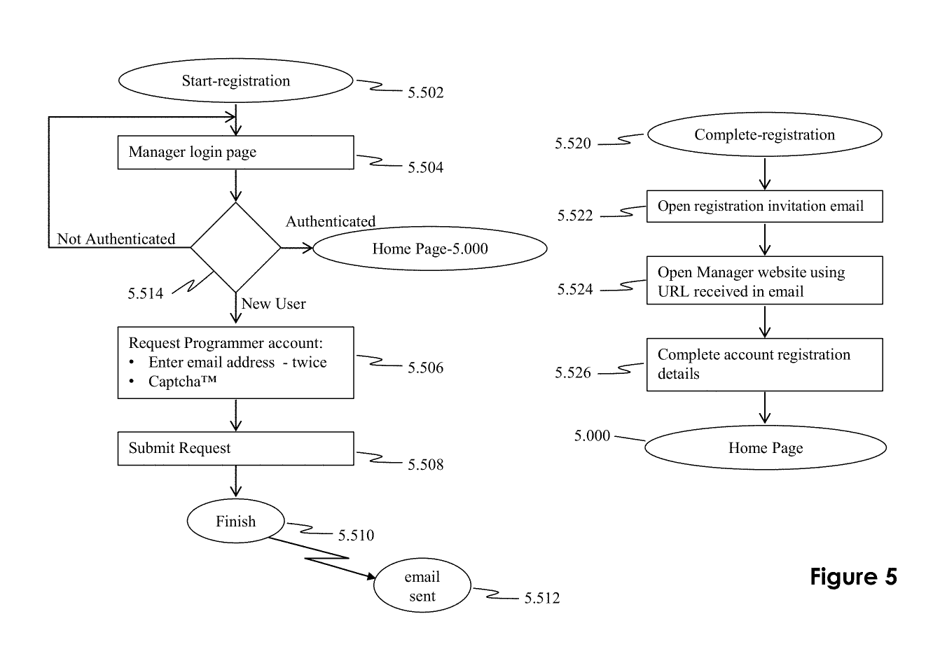

FIG. 5 is a flowchart that describes the process followed by a user to register as a programmer as part of a preferred embodiment. The user is in communication with the manager over the internet using a web browser (9.600) or an App. The process validates the user by using email to contact the user to complete the registration process.

The steps detailed below are provided as an example only in order to illustrate the principals involved:

Item 5.502—a user wishing to register on the system as a programmer uses a web browser to access the manager via the internet by entering the address of the manager's web site into the address field of the web browser (9.601) or by using a bookmark or other means. A tablet or smart phone App can also be used in lieu of a web browser.

Item 5.504—the manager serves up a login page allowing a user to either register as a new user by requesting an account, or to enter a user name and password. Once authenticated, the user is able to enter the site and access the home page (5.000/6.000)

Item 5.514—if the user has not authenticated due to user name or password mismatch, the user is requested to re-enter the user name and password. After three or so attempts, the account is locked out for a period of time and the account owner is notified by email.

Item 5.506—in order to register as a programmer a user enters an email address which is used by the system for the initial registration process and completes a Captcha™ or equivalent used by the manager to ensure that a user attempting to access the manager website is a person rather than a robot.

Item 5.508—the user accepts the terms and condition and submits the application which results in the session terminating (5.510)

Item 5.512—the manager confirms the user's details and sends an email containing temporary login credentials to the email address specified by the user

Item 5.520—after receiving the email containing temporary login credentials the user proceeds to finalize the programmer account setup as follows:

Item 5.522—the user opens the email containing the temporary login credentials and confirms the details

Item 5.524—the user accesses the manager website using the URL contained in the email received. This can be done by launching the link (URL) contained in the email or by launching a web browser and inserting the URL into its address field (9.601).

Item 5.526—the user enters the details required to finalize the programmer account setup, including setting a password and nominating password recovery questions and answers following which the user is set up as a programmer

Item 5.000—at this stage the user (now a programmer) is directed to the home page (6.000)

FIGS. 6a, 6b and 6c detail the steps that a programmer using a web browser (9.600) or an App manages content lists, USPDs and other aspects of their account.

The steps detailed below are provided as an example only in order to illustrate the principals involved:

Item 6.504—the programmer uses a web browser to access the manager via the internet by entering the address of the manager's web site into the address field of the web browser (9.601) or by using a bookmark or other means. A tablet or smart phone App can also be used in lieu of a web browser. The manager serves up the login page.

Item 6.506—in order to enter the site, the programmer enters the account credentials. If the programmer holds a valid account the manager serves up the home page (6.000).

Item 6.508—the programmer is provided with a number of options as to what action to take next

Item 6.510—allows the programmer to manage their account settings, including email address, password and the like

Item 6.512—allows the programmer to logout and exit the site

Item 6.514—allows the programmer to nominate additional users with access to this account

Item 6.516—provides the programmer with a choice of registering USPDs (FIG. 6b) with the manager

Item 6.518—allows the programmer to define a content playlist (FIG. 6c)

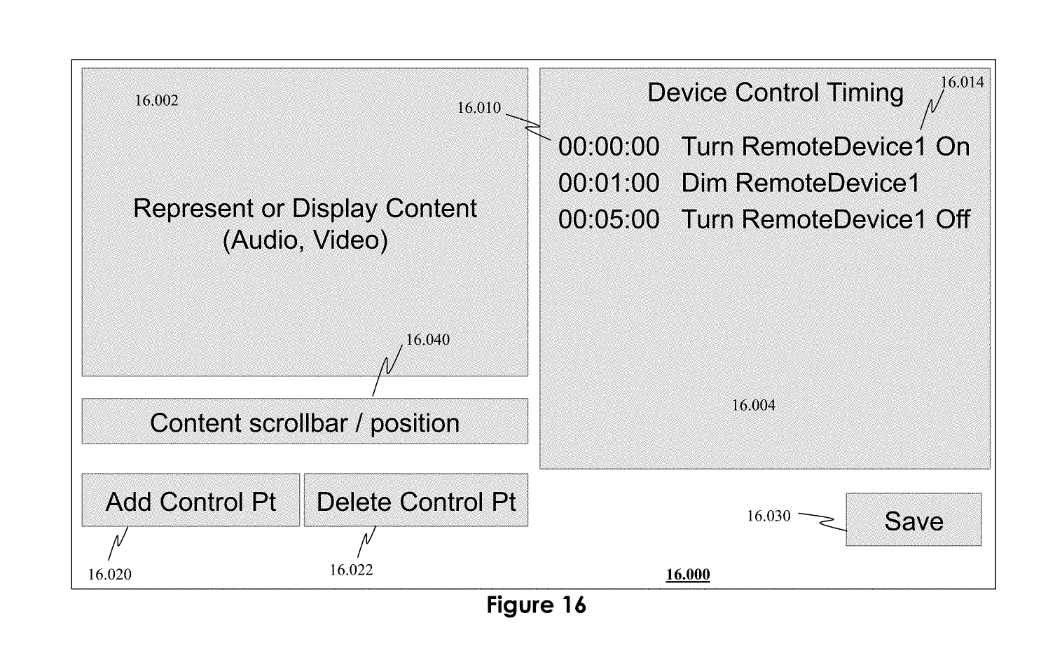

Item 6.520—allows the programmer to define automation sequences associated with playlist items as described in FIG. 16

Item 6.522—allows the programmer to define notifications preferences based on sensors changing state as disclosed above

Item 6.552 (FIG. 6b)—the programmer is directed to this step from 6.516. This flowchart details the way the programmer registers one or more USPDs (6.556) or returns to the home page (6.000)

Item 6.556—this step allows the programmer to register a USPD with the manager by entering the USPD's parameters, including its unique identifier and a name by which it is to be referred to

Item 6.554—the programmer may elect to register another USPD by repeating step 6.556 or to return to the home page (6.000)

Item 6.652 (FIG. 6c)—the programmer is directed to this step from 6.518. This flowchart details the way a programmer enters one or more playlists and associate the playlists with one or more USPDs.

Item 6.566—the programmer defines a new program by giving it a name

Item 6.568—the programmer directs their web browser (9.600) or App to the address of the nominated content by entering the address into the web browser's address field (9.601) or by other means

Item 6.570—the programmer associates the address or URL of the site containing the content being displayed on the web browser with one or more USPDs and proceeds to define the content playback mode, whether it is to be immediate, user initiated etc.

Item 6.572—the finalized playlist details are saved by the programmer—the data is stored in the database associated with the manager 7.250 (FIG. 7A) and is sent (8.822—FIG. 8) to the selected one or more USPDs using a message format as shown in 10.270 FIG. 10

Item 6.654—the programmer is given the option of continuing with the definition of playlist material (6.566) or to return to the home page (6.000)

While the tasks in FIG. 5 and FIG. 6 are detailed algorithmically, it is clear to one skilled in the art that the user interface implemented via an App or web browser can achieve the same outcome by the user directly selecting the desired action.

FIG. 7A details the contents of a playlist. The playlist is stored in a database register at the manager (1.200) which associates the playlist with one or more USPDs. Each USPD may be issued with a unique identifier (SID) (7.252) which may be a function of the device's MAC address, and is used to identify the USPD to the manager during activation.

Field 7.254 is the programmer ID—it is the programmer's user name and is used to uniquely identify the account of the programmer responsible for the playlist.

Field 7.256 is the network reference to the content to be retrieved by the USPD as defined by the programmer.

Field 7.258 defines the playback mode used by the USPD, including the following:

Automatic playback immediate—the playback by the USPD of the streamed content starts immediately after the receipt of the playlist from the manager

Automatic playback scheduled—the playback of the streamed content by the USPD starts at a time scheduled by the manager—the programmer may receive instant notification if the playback has commenced or not

Automatic playback following the completion of previous playlist item—this allows an automatic playlist to be generated for the USPD to run through

User initiated and controlled—this allows the playback of the playlist by the USPD to be controlled by the user using simple commands such as Play, Pause, Fast Forward, Rewind and Stop which may be issued verbally

Field 7.260 defines the playback schedule for the playlist item, including time and day.

Field 7.262 defines the quality of service (QoS) associated with the USPD—this allows the selection of content compression appropriate to the bandwidth available to the USPD, which can be predetermined as part of the configuration process thereby avoiding the delivery of high definition content to a user with a limited bandwidth internet connection.

Field 7.264 may contain the encrypted payment details that may be associated with the playlist item. This information is only required when the USPD is accessing paid content that requires the USPD to supply payment information. As part of the preferred embodiment the account payment information is not stored in the database. The payment information can only be entered by the programmer when the associated one or more USPDs are online and in communication with the manager. The payment information entered by the programmer is sent directly by the manager to the one or more USPDs within message 10.270 and stored in an encrypted manner in the USPDs' memory (12.126.1 and 12.126.2). For additional security the payment details can be deleted after the content is streamed, or after some time has passed.

Field 7.268 contains the Automation Instructions, such as an XML File—FIG. 17, associated with driving home automation devices in a manner synchronized with the content being played by the USPD

FIG. 8 illustrates the top level message flow that may be associated with one aspect of the embodiment of this invention in which:

Item 8.810 is the programmer entering the account credentials to log into the manager using a web browser or an App in order to define one or more playlists to be downloaded into a USPD.

Item 8.812 is the manager acknowledging the programmer has logged on successfully.

Item 8.814 shows the programmer accessing a site on the internet that contains the desired content.

In item 8.815, the programmer obtains the internet location of the selected content.

Item 8.816 shows the programmer associating the reference to the internet location containing the content with the one or more USPD—this information is stored in the database as shown in FIG. 7A.

Item 8.818 shows the programmer logging out of the manager web site. This action may occur at any time.

Item 8.820 shows the manager delivering an instant notification to the one or more users associated with the one or more USPDs to indicate that a playlist is available for their enjoyment. The instant notification may be indicated on the USPDs or may be routed to a different device based on programmer preference.

Item 8.822 shows the manager delivering the configuration data to the one or more USPDs, including the reference to the content, the playback mode, playback schedule etc. The message format used is shown in FIG. 10 (10.270).

Item 8.824 shows the USPD acknowledging the reception of the configuration data from the manager.

Item 8.826 shows the USPD accessing the content using the network reference provided by the manager. This message may also contain the encrypted payment details required to access the content.

Items 8.828 and 8.830 shows the data being streamed from the content provider to the one or more USPDs. The USPD is at this point playing the content to the user or users.

Item 8.832 shows the user Pausing the playback which temporarily halts the streaming of data from the content provider. Pausing the streaming may also occur by the USPD simply stopping to send content fetch request messages.

Items 8.834 shows the audience restarting the playback by pressing Play or saying Play which causes the streaming of data from the content provider to restart—shown as 8.836 through to 8.838. As noted above, there may not be a need for a specific ‘Play’ message to resume streaming. The content provider continues to stream the content until the content delivery is completed, or until the content provider receives a further interrupt or halt instruction.

While the message flow detailed in FIG. 8 is not exhaustive, it contains sufficient details to illustrate the embodiment of the invention. A person skilled in the art will be able to implement alternative embodiments.

FIG. 9 illustrates the operation of a known web browser (9.600) in the context of this invention as a user interface used by the programmer (2.100) to access the manager (2.200) with a PC (9.100) when not using an App. After the login process detailed above, the programmer selects 6.518—Program Content. The manager (2.200) serves up a web page which triggers an emulator program (9.602) that executes a program called an Applet (9.604) in the web browser (9.600). The Applet (9.604) may be a Java™ application or implemented using Java Script and is referred to as a web browser extension. The web browser extension (9.604) maintains an encrypted IP connection (9.100.1) via the PC's (9.100) internet connection (9.608) via port 443 or other suitable IP port using an IP tunnel implementation such as HTTPS to the manager (9.200). Once the IP tunnel (9.100.1) has been established by the web browser extension (9.604), the web browser (9.600) allows the programmer to access (9.900) various content sites (9.700.2) via the internet (9.800) using the PC's internet connection (9.620) while simultaneously maintaining a connection to the manager (9.200) via the internet (9.800) using encrypted IP connection 9.100.1 which allows the content site nominated by the programmer (2.100) by entering its address into the web browser's address bar (9.601) to be recorded by the manager (9.200) and to be associated with one or more USPDs (2.300.3).

Once the programmer (9.100) enters the address of the content in the web browser's address bar (9.601), the web browser establishes a connection (9.900) using the PC's internet connection, over the internet (9.800) to the nominated site (9.700.2). The programmer than uses a menu provided by the web browser extension (9.604) to associate that site with the playlist.

The programmer PC's (9.100) internet connection 9.608 and 9.620 are identical and two separate connections are shown for convenience.

The manager (9.200) is connected to the internet (9.800) via a data link shown as 9.201.

The content (9.700.2) is connected to the internet (9.800) via a data link shown as 9.401.

FIG. 10 details the payload 10.270 of the message sent by the manager to the USPD as part of the playlist download process.

Field 10.272 is the USPD's unique identifier (SID)

Field 10.274 is the programmer ID, such as the user name—it is used to uniquely identify the programmer responsible for the playlist being configured in the one or more USPDs.

Field 10.276 is the network reference to the content to be retrieved by the USPD as defined by the programmer.

Field 10.278 defines the playback mode for the playlist item as described above.

Field 10.280 defines the playback schedule for the playlist item.

Field 10.282 defines the quality of service (QoS) associated with the USPD as described above.

Field 10.284 contains the encrypted payment details needed to access streaming content sites which require payment or account information to be entered prior to accessing the content nominated by the playlist, such as user name, password and may include information such as credit card details, PayPal account details etc. This information is not required when accessing free content.

Field 10.286 contains the home automation Instructions in the form of an XML File as detailed in FIG. 17 or an equivalent form which is associated with driving home automation devices in a manner synchronized with the content being played by the USPD. The home automation instruction sequence may also be obtained from the content site along with the streaming content.

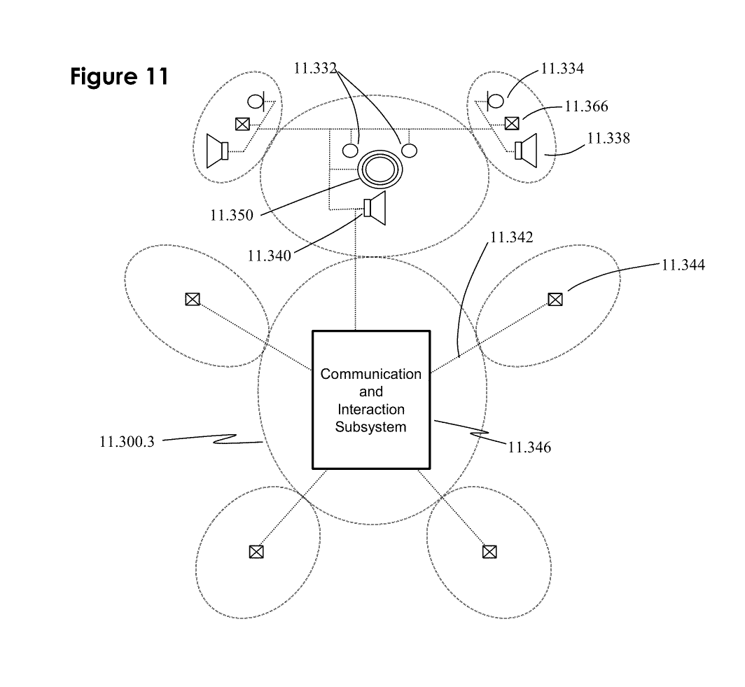

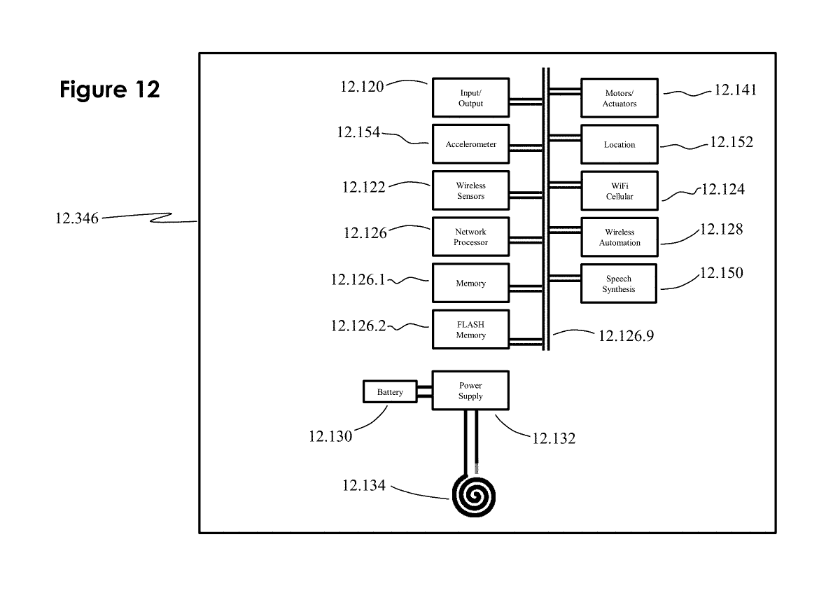

FIG. 11 is the preferred embodiment of the USPD (11.300.3) as a toy. The control and processing components of the USPD are contained in the Communication and Interaction Subsystem (11.346), which is further detailed in FIG. 12.

The USPD (11.300.3) is supplied with a number of interface devices such as touch sensors (11.344, 11.366), speakers (11.338 and 11.340), microphones (11.334) and visual indicators, such as multi-color LEDs (11.332) and gesture recognition devices such as 11.350. The assembly practice followed ensures that the device does not endanger young children even when the toy is dismantled by avoiding the use of small-independent components that may be swallowed.

The various touch-sensors, speakers, microphones, gesture recognition sensors and visual indicators may be interconnected by a local data bus (11.342). Point-to-point cabling may also be used for the interconnections.

The gesture control interface (11.350) allows control of the USPD via gestures including hand movements eliminating the need to press buttons and the like.

FIG. 12 details the control and processing components of one embodiment of the USPD (12.346) which includes the following subsystems interconnected to the network processor (12.126) via processor bus (12.126.9):

Subsystem 12.120 is the Input/Output interfaces used to sense the status of touch switches, gesture recognition sensors and drive visual indicators such as multi-color LEDs and interface to microphones and speakers. Where a local data bus such as 11.342 is used to communicate with the abovementioned peripheral devices, it is terminated on this (12.120) subsystem.

Subsystem 12.122 is the interface to wireless sensors such as proximity sensors, passive infrared sensors (PIR), magnetic contact sensors, smoke detectors and the like generally using the ISM wireless band with proprietary modulation and coding schemes. These sensors may be learned into the USPD by, for example, bringing a sensor close to the USPD and pressing one of the touch sensors for a few seconds, or alternatively allowing the USPD to identify the presence of the sensor and allowing the programmer to associate it with the USPD. The sensors may be used to modify the playback of content and automation sequences and may also be used to trigger notifications to the users as disclosed above.

Subsystem 12.124 is the wireless IP interface subsystem supporting a WiFi interface to the local area network (LAN) used by the USPD to connect to the internet in order to communicate with the manager and the internet site containing the content over the user's broadband network. This interface is configured such that when the USPD starts up it may operate for a short time as a WiFi hot-spot, allowing a local user to connect to the USPD using a WiFi enabled PC, tablet or smart phone to configure the USPD to carry out a local WiFi network survey and to connect to the preferred WiFi local area network (LAN) to be used by the USPD by the user nominating the RSID of the preferred network and entering the network encryption password. Optionally a cellular and/or Ethernet interface may also be supported by this subsystem. When equipped with a cellular interface, such as LTE, the USPD does not require LAN access to access content.

Subsystem 12.126 is the network processor used to control the operation of the USPD. Generally the network processor includes a CPU, watchdog timer, random access memory such as static or dynamic RAM (12.126.1) and persistent memory such as FLASH (12.126.2). The network processor may execute an operating system such as a version of the Linux operating system or equivalent. When loaded with the appropriate software the network processor can be configured to carry out speech recognition.

Subsystem 12.128 is the local wireless network interface used to control home automation devices using one or more of the known Zigbee, Z-Wave, Bluetooth-Low Energy (BLE), 6LoWPAN and the like and other similar wireless technologies. This interface allows the USPD to wirelessly control lights, curtains and to control other devices by, for example, turning them on and off using mains power in a manner synchronized with the content being streamed and played by the USPD. These wireless devices are learned-in to the USPD when they are added from time to time using the USPD's automatic detection capability. An additional benefit is derived from the ability of wireless technologies such as Bluetooth to connect to wireless speakers which are used to play back audio streams or to generate other sound effects.

Subsystem 12.130 is the built-in rechargeable LiPO or similar battery used to power the USPD when it is not powered from the AC mains

Subsystem 12.132 is the power supply for the USPD whether powered from the mains or from the rechargeable battery. It is also used to charge the battery (12.130) and report its level of charge.

Subsystem 12.134 is the induction pickup coil used to power the USPD from an external power source such as the mains. The charger (13.136) generates an inductive field which is picked up by the pickup coil (12.134). The current generated in the pickup coil is rectified by the power supply (12.132) and is used to power the USPD and charge the battery (12.130). This arrangement avoids the need to plug a charging cord into the USPD.

Subsystem 12.141 is a specialized set of output devices such as stepper motors and actuators controlled by the network processor (12.126) as defined by the programmer and used to enhance the interactive experience with the USPD by for example allowing a toy to support head movement, eye movement and in the case of the USPD embodiment as a robot (FIG. 15) supporting complex-multifaceted movement.

Subsystem 12.152 is a location identifying device such as GPS that can be coupled with the USPD to support location-based play-back

Subsystem 12.154 is an accelerometer which may be used to identify that the USPD is being manhandled in some way thereby allowing the appropriate response to be generated by the software, including the activation of the text-to-speech module (12.150)

Subsystem 12.150 is a speech synthesis module including capabilities such as text to speech conversion

Other subsystems including video cameras and the like may be added to allow the USPD to double as a surveillance device

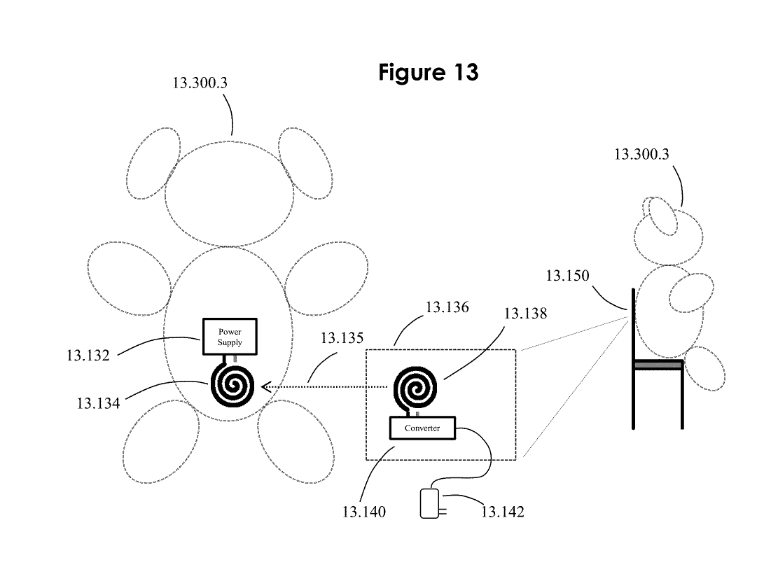

FIG. 13 details a powering arrangement that may be used in the embodiment of a USPD designed as a toy (13.300.3).

The USPD (13.300.3) may be externally powered when placed in a cradle (13.150). The cradle (13.150) may also be used to charge the USPD battery (12.130). The rear of the cradle (13.150) contains an induction generator (13.136) which is mains powered by for example, a plug-pack (13.142). A converter (13.140) converts the mains power to the frequency and waveform that are suitable for inductively transferring power (13.135) to the USPD (13.300.3). Coil 13.138 is used to radiate the inductive field to the USPD pickup coil (13.134).

The USPD pick-up coil (13.134) feeds the induced current to the USPD's power supply (13.132) to be used to power the USPD and charge its battery.

A small magnet (14.138) may be placed at the rear of the cradle (14.150) to ensure that the USPD (14.300.3) remains in position while it is externally powered. The magnet attaches to a small iron (or other magnetic material) button at the rear of the USPD (14.134). Other arrangements to hold the USPD in the cradle are possible such as using clips.

FIG. 15 details an alternative USPD shaped as a robot (15.300.3) which includes the following subsystems:

Servo operable legs (15.141.11 and 15.141.13)

Clasping ‘hands’ (15.141.7 and 15.141.9)

Servo operable arms (15.141.3 and 15.141.5)

Servo operable head (15.141.1)

It is clear to one skilled in the art that there are numerous possibilities for the shape and functionality, including the controllable elements that may be associated with a USPD.

FIG. 16 details the programmer interface (16.000) which may be used to define and associate automation and other control or meta data with the content being streamed. It is shown by way of example as a web browser window, but may also be implemented as part of an App for a tablet or smart phone.

The programmer (1.100) plays back the content which is represented in the content window (16.002). The content horizontal scrollbar (16.040) is used to indicate the position of the content currently being viewed or listened to. The programmer has the option of adding (click 16.020) a control point device or, if one already exists, deleting one (click 16.022).

When adding or deleting a control point (16.020/16.022) the programmer is able to select the appropriate one which was previously learned-in, from a drop-down menu. The resultant program appears in the device control timing window (16.004) detailing the device type being controlled (16.014) and the time it will be activated or deactivated (16.010) relative to the content playback timeframe.

When the program definition has been completed, the programmer may elect to save the device control information by clicking the save button (16.030). This saves the information in the manager database in the form of a command file that may use the XML file format (FIG. 17) or another suitable format. The programmer may elect to play back the content in which case the device control timing window (16.004) will display the actions of the various devices being controlled at the appropriate time in the content.

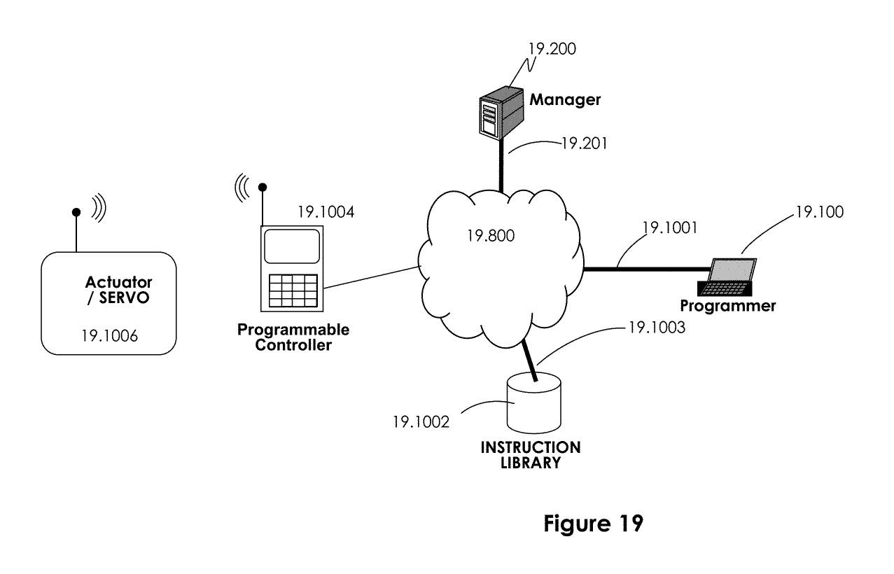

FIG. 19 illustrates an arrangement adapted to control home automation devices according to an embodiment of the invention. The system includes a programmer terminal 19.100, a manager terminal 19.200, an instruction library server 19.1002, and a programmable control device 19.1004 all connected to a network such as the internet 19.800. The programmable control device can communicate with an actuator or servo device 19.1006 via a local communication system, such as a LAN or wireless LAN. The programmer 19.100 can set up instructions for the programmable control device 19.1004 via the manager 19.200 by first accessing the instruction library server 19.1002 via the internet and selecting the identification of the instructions to be applied to the actuator 19.006 by the programmable control device 1.004. The programmer 19.100 can then provide the instruction identification information to the manager, and the manager can forward the instruction information to the programmable control device. When the programmable control device receives the instruction information, which can include time-of-day instruction added by the programmer, the programmable control device retrieves the instructions from the instruction library server and uses the instructions to control the actuator 19.006.

Alternatively, once the programmer has retrieved the instruction identification information from the instruction library server, the programmer can forward the instruction identification information to the programmable control device 19.1004, and the programmable control device can retrieve the instructions from the instruction library server.

FIG. 17 details an example command file using the XML format that may be used as part of the preferred embodiment to control home automation and other devices, including servo-motor or actuator associated with or built into the USPD. It should be noted that the invention can support alternative file formats to achieve the same outcome. The command file is sent to the USPD using the message format illustrated in FIG. 10 (10.270) and can support a range of operations including associating automation commands with the content playback and orchestrating the coordinated playback with two or more associated USPDs.

Field 17.400 through to Field 17.490 define the automation actions and may be extended to generate subtitles.

Field 17.410 defines the first action. It is triggered at the time nominated in field 17.412 given from the starting time of the content playback.

The actions specified in filed 17.410 include subtitles (17.414) and actions 1 and 2 (17.416). The subtitles allow text to be displayed on the video screen whereas the actions activate home automation devices, such as a Z-Wave switches to control physical devices around the audience. For example Action 1 could be dim the living room light to 50% and Action 2 could be set living room temperature 77° F. Other Actions could be defined as required. It should be noted that the term home automation is used to cover a range of automation actions that may not necessarily involve controlling home devices, for example one could control a train set.

Field 17.420 is the second action in the sequence triggered at a later time, in this case 30 seconds from the commencement of the USPD playing the content. Here again defining subtitles and Actions 3 and 4 which could be the activation of other devices, such as for example the popcorn machine and the coffee maker.

While the XML file is shown above as being used to control automation and generate subtitles, it would be clear to one skilled in the art that the XML file can also include an alternative sound track to replace the one associated with the original content or to inject advertisements, such as images, video clips and/or audio into the streamed content targeted at the user.

When orchestrating the coordinated playback with multiple USPDs, each device taking part in the coordinated playback may be provided with the same XML file to control the timing of the various playback segments and with the same or different playlist. This arrangement can for example support playback device one starting to be joined some time later by playback device two and so on to generate a polyphonic effect.

In a further embodiment, a number of users of the USPDs can contemporaneously participate in an on-line contest, such as bingo, or a quiz by using a user input button or the like on a USPD. In a further enhancement, the management center can compensate for round-trip delay by synchronization of the clocks on each USPD and using timestamps on critical messages so each participant has an equal opportunity to submit a response before other participants.

In the case of a quiz, the questions may be streamed to the USPDs of a number of contestants, and the contestants can select a response from a plurality of options displayed on the player's USPD display screen. This response can be delivered to the content repository, which can adjudicate the first received response, and determine the winner on the basis of the number of correct responses received from a set of such questions.

In the case of a game such as bingo, each player may have a pseudo-randomly generated subset of numbers or images delivered from the content repository and displayed on the screen of the player. The numbers or images for each player can be uniquely selected for each player from a large set of images or numbers. The content repository can then send randomly selected individual numbers from within the larger set to each player and each player can mark off the individual numbers or images which correspond with the numbers or images in the player's unique sub-set of images or numbers until a required number of numbers or images have been marked off by the player. Each time a player achieves a match between the player's unique subset and the randomly generated sequence, this information is returned to the content repository, which adjusts for the round trip delay and identifies the first player to meet the required criteria such as achieving a predetermined number of matches with the random sequence. The first player to accumulate the required number of matching numbers or images is the winner. Alternatively, the player may be required to press a button or screen display when they have a match.

FIG. 18 illustrates the data exchange between the USPD and a network based speech recognition engine (2.801) used to provide the user with speech-based control of the USPD.

Steps 18.1812, 18.1814, 18.1816, and 18.1818 illustrate a first unsuccessful attempt by a user to activate the USPD. The user pronounces a recognition command, such as the name of the USPD at 18.1812. The USPD captures the audio and forwards it to a network based speech recognition engine (2.801) at step 18.1814.

However, the captured audio representing the spoken command has, in this instance, been corrupted, and the speech recognition engine returns an error token at 18.1816. The USPD then plays an error message to the user at 18.1818. The voice response is generated by a speech synthesis module (12.150) incorporated in the USPD (2.300.3).

A successful request is illustrated from 18.1912 to 18.1926.

At 18.1912, the user pronounces the recognition command, which is captured by the USPD which forwards the captured command to the speech recognition engine at 18.1914. The speech recognition engine recognizes the command and sends a recognition token to the USPD at 18.1916. The USPD generates a response to the user at 18.1918, which may be speech based, and may initiate an action, such as commencing to play the next item on the downloaded playlist.

At 18.1920, the user then sends a verbal action request, such as Pause, Fast Forward etc. to the USPD which captures the action request and forwards the captured action request to the speech recognition engine at 18.1922. The speech recognition engine converts the action request to an action instruction and forwards it to a content library at 18.1924. The content library then acts on the command, including delivering the requested content to the USPD at 18.1926.

The speech recognition engine can be collocated with the content library, or it may be able to communicate with the content engine via the internet.

It will be recognized that, instead of a request for content, the user could request an action, for example, the activation of a specified device such as a servo-motor or actuator controlled via the USPD. In this case, either the speech recognition engine or an action library instructed by the speech recognition library could send an activation command to the USPD, which could then activate the specified device.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present invention are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Accordingly, the present disclosure is not to be seen as limited by the foregoing description, but is only limited by the scope of the appended claims.

1. A content retrieval control system including:
a management center;
programming capability;
and
one or more managed terminals; wherein
the managed terminals are connectable to one or more content repositories;
the content retrieval control system including one or more association registers associating each managed terminal with the programming capability;
the content retrieval control system includes one or more programmable content delivery schedules for each managed terminal adapted to store content identification information identifying selected content;
the programming capability is adapted to program the content delivery schedules with content identification information identifying content in one or more of the content repositories for each managed terminal with which the programming terminal is associated;
the management center is adapted to deliver the content delivery schedules including content identification information to each corresponding managed terminal;
each managed terminal is adapted to use the content identification information to retrieve content identified by the content information from a content repository.

2. A content retrieval control system as claimed in claim 1, wherein the programming capability includes one or more programming terminals.

3. A content retrieval control system as claimed in claim 1, wherein the content identification information includes the access addresses for selected content at a content repository.

4. A content retrieval control system as claimed in claim 1, wherein the content identification information includes associated content retrieval time information.

5. A content retrieval control system as claimed in claim 1, wherein the management center is adapted to facilitate the delivery of home automation information to one or more managed terminals.

6. A content retrieval control system as claimed in claim 1, wherein each managed terminal is adapted to receive home automation information.

7. A content retrieval control system as claimed in claim 1, wherein each managed terminal is adapted to retrieve home automation information from a content repository.

8. A content retrieval system as claimed in claim 5, wherein two or more managed terminals are adapted to retrieve the same content contemporaneously.

9. A method of retrieving content from one or more content repositories by one or more managed terminals, the method including the steps of:
programming content retrieval schedules with content identification information identifying selected content in one or more of the content repositories for each managed terminal;
delivering the content identification information to each corresponding managed terminal;
using the content identification information to retrieve selected content identified by the content identification information from a content repository.

10. A managed device adapted to:
receive content identification information;
retrieve selected content from content repository using the content identification information;
convert content received from a content repository to a human comprehensible format, the managed device including:
a first processor;
at least first communication interface;
at least a first output generator;
a content information store;
wherein the first communication interface is adapted to interface the managed device to a communication network,
the first output generator is adapted to generate an output in human-comprehensible format, and
the processor is adapted to:
store content identification information identifying selected content in a content information store,
retrieving at least part of the selected content from an on-line content store;
convert the selected content to a human-comprehensible format by an output generator.

11. A managed device as claimed in claim 10, wherein the selected content is streaming content.

12. A managed device as claimed in claim 10, wherein the managed terminal is adapted to receive home automation instructions and to send the home automation instructions to one or more controllable devices.

13. A managed device as claimed in claim 10, wherein the managed terminal is adapted to retrieve home automation instructions and to send the home automation instructions to one or more controllable devices.

14. A managed device as claimed in claim 10, wherein the managed device includes one or more user interfaces, at least one of which includes gesture recognition capability.

15. A programming terminal adapted to program the retrieval of selected content by one or more managed terminals, the programming terminal including:
a management center user interface adapted to display an association register identifying each managed terminal with which the programming terminal is associated;
the managed terminal association register identifying preferences for each managed terminal;
wherein the programming terminal is adapted to register preferences for each managed terminal with a management center adapted to deliver the preferences and content identification information to each managed terminal.

16. A programming terminal as claimed in claim 15, wherein the preferences include content identification information.

17. A programming terminal as claimed in claim 15, wherein the preferences include content retrieval time information.

18. A management center for a content retrieval system, the management center including:
a first communication interface adapted to enable communication between one or more programming terminals and the management center;
a second communication interface adapted to enable communication between the management center and one or more managed terminals;
a register associating each programming terminal with one or more managed terminals;
a programmable content retrieval schedule for each managed terminal controlled via the associated programming terminal;
wherein the management center is adapted to transmit a corresponding content retrieval schedule to each managed terminal.

19. A method of loading operating instructions into a network-connected operable device from a network-connected programmable controller device including the steps of: using the programming device to retrieve instruction identification information from an instruction server, forwarding the instruction identification information to programmable controller, and initiating the download of corresponding instructions from the instruction server to the programmable controller, and using the downloaded instructions to control an actuator or servo device.
